(19) United States
(12) Patent Application Publication
(10) Pub. No.: US 2025/0323374 A1
(43) Pub. Date: Oct. 16, 2025

(54) BATTERY ELECTRODE STACK BRACKET CONFIGURED TO PERMIT GAS FLOW THERETHROUGH

(71) Applicant: GM GLOBAL TECHNOLOGY OPERATIONS LLC, Detroit, MI (US)

(72) Inventors: Meng JIANG, Rochester Hills, MI (US); Lei WANG, Rochester Hills, MI (US); Fengkun WANG, Rochester Hills, MI (US); Liang XI, Northville, MI (US); Louis G. HECTOR, JR., Shelby Township, MI (US)

(21) Appl. No.: 18/635,781

(22) Filed: Apr. 15, 2024

(51) Int. Cl. H01M 50/291; H01M 50/103; H01M 50/342

(52) U.S. Cl. CPC H01M 50/291; H01M 50/103; H01M 50/3425

(57) ABSTRACT

A battery cell including: an enclosure; a stack of anode electrodes and cathode electrodes within the enclosure; a vent configured to open to release gas out from within the enclosure when pressure within the enclosure exceeds a threshold; and a bracket within the enclosure supporting the stack, the bracket defining at least one passageway through the bracket configured to allow gas to flow through the bracket to the vent.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to brackets configured to support an electrode stack within a battery enclosure.

Electric vehicles (EVs), such as battery electric vehicles (BEVs), hybrid vehicles, and/or fuel cell vehicles, include one or more electric machines and a battery system including one or more battery cells, modules, and/or packs. Each battery includes electrodes with current collectors coated with an active material. A power control system is used to control charging and/or discharging of the battery system during charging and/or driving.

### SUMMARY

The present disclosure provides for, in various features, a battery cell including: an enclosure; a stack of anode electrodes and cathode electrodes within the enclosure; a vent configured to open to release gas out from within the enclosure when pressure within the enclosure exceeds a threshold; and a bracket within the enclosure supporting the stack, the bracket defining at least one passageway through the bracket configured to allow gas to flow through the bracket to the vent.

In further features, the battery cell is configured as a prismatic cell.

In further features, the enclosure includes a bottom surface, and the vent is at the bottom surface.

In further features, the enclosure includes a bottom surface, and the bracket is seated on the bottom surface.

In further features, the bracket includes coils defining the at least one passageway.

In further features, the coils have a uniform pitch.

In further features, the coils include upper coils having an upper pitch and lower coils having a lower pitch, the upper pitch is less than the lower pitch.

In further features, the coils include upper coils having an upper pitch and lower coils having a lower pitch, the upper pitch is greater than the lower pitch.

In further features, an upper diameter of the bracket is less than a lower diameter of the bracket.

In further features, the bracket includes a base and a plurality of legs extending from the base, the legs defining the at least one passageway for gas to flow through the bracket.

In further features, the at least one passageway further includes an opening defined by the base.

In further features: the bracket is a first bracket, the battery cell further including a second bracket; and the first bracket and the second bracket are on opposite sides of the vent.

In further features, the bracket includes an upper end in contact with the stack, a lower end in contact with a bottom surface of the enclosure, and an intermediate surface extending between the upper end and the lower end.

In further features, the intermediate surface extends perpendicular to the bottom surface of the enclosure.

In further features, the intermediate surface extends at an acute angle relative to the bottom surface of the enclosure.

The present disclosure further provides for, in various features, a battery cell including: a prismatic enclosure; a stack of anode electrodes and cathode electrodes within the prismatic enclosure; a vent at a bottom surface of the prismatic enclosure, the vent configured to open to release gas out from within the prismatic enclosure when pressure within the prismatic enclosure exceeds a threshold; and at least one bracket within the prismatic enclosure supporting the stack, the at least one bracket seated on the bottom surface of the prismatic enclosure and defining passageways on opposite sides of the vent for gas to flow through the at least one bracket to the vent.

In further features, an isolation material is between the stack and the at least one bracket.

The present disclosure also provides for, in various features, a battery cell including: a prismatic battery cell enclosure; an anode terminal and a cathode terminal at an upper, exterior surface of the prismatic battery cell enclosure; a stack of anode electrodes and cathode electrodes within the prismatic battery cell enclosure, the anode electrodes connected to the anode terminal and the cathode electrodes connected to the cathode terminal; a vent at a bottom surface of the prismatic battery cell enclosure, the bottom surface is opposite to the exterior surface of the prismatic battery cell enclosure, the vent configured to open to release gas out from within the prismatic battery cell enclosure when pressure within the prismatic battery cell enclosure exceeds a threshold; and at least one bracket within the prismatic battery cell enclosure supporting the stack, the at least one bracket seated on the bottom surface of the prismatic battery cell enclosure and defining passageways on opposite sides of the vent for gas to flow through the at least one bracket to the vent.

In further features, the at least one bracket includes a pair of coils on opposite sides of the vent.

In further features, the at least one bracket includes a base and a plurality of legs extending from the base, the legs defining the passageways.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side, cross-sectional view of an exemplary battery cell including an electrode stack supported within an enclosure by brackets in accordance with the present disclosure;

FIG. 2A is another cross-sectional view of the exemplary battery cell including brackets in accordance with the present disclosure configured to support the electrode stack;

FIG. 2B illustrates a bottom area of FIG. 2A;

FIG. 2C is a side view of an exemplary bracket in accordance with the present disclosure configured to support the electrode stack;

FIG. 2D is a side view of an additional bracket in accordance with the present disclosure configured to support the electrode stack;

FIG. 2E is a side view of another bracket in accordance with the present disclosure configured to support the electrode stack;

FIG. 2F is yet another bracket in accordance with the present disclosure configured to support the electrode stack;

FIG. 3A is a cross-sectional view of a bottom area of the exemplary battery cell including another exemplary bracket in accordance with the present disclosure configured to support the electrode stack;

FIG. 3B is a side view of the bracket of FIG. 3A;

FIG. 3C is a bottom view of the bracket of FIG. 3A;

FIG. 4A is a cross-sectional view of a bottom area of the exemplary battery cell including additional exemplary brackets in accordance with the present disclosure configured to support the electrode stack;

FIG. 4B is a bottom view of the brackets of FIG. 4A;

FIGS. 5A, 5B, and 5C are side views of additional exemplary brackets in accordance with the present disclosure configured to support the electrode stack, the brackets each configured to be folded as illustrated in FIG. 6 and FIG. 7;

FIG. 6 is a cross-sectional view of a bottom area of the exemplary battery cell including the bracket of FIG. 5A folded in a wave-like manner in accordance with the present disclosure to support the electrode stack; and

FIG. 7 is a cross-sectional view of a bottom area of the exemplary battery cell including the bracket of FIG. 5A folded at right angles in accordance with the present disclosure to support the electrode stack.

In the drawings, reference numbers may be reused to identify similar and/or identical elements.

### DETAILED DESCRIPTION

The present disclosure includes various brackets configured to support an electrode stack in a battery cell enclosure. The present disclosure applies to any suitable battery cell, such as, but not limited to, prismatic can cells including tall can cells. The brackets define passageways for gas to flow through to relieve pressure within the battery cell, such as during a thermal runaway event, for example. Gas released during a thermal runaway event is able to flow through the brackets to a vent, through which the gas is released once gas pressure within the enclosure exceeds a threshold limit. The present disclosure is configured for use with tall prismatic cells with a bottom vent, and any other suitable battery cell configuration including a pathway for gas flow.

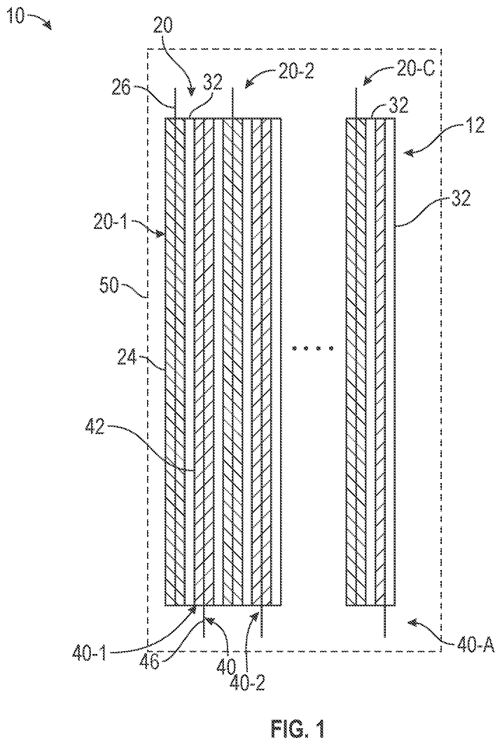

FIG. 1 illustrates an exemplary battery cell 10 configured to include a bracket in accordance with the present disclosure, the bracket configured to support a battery electrode stack. The battery cell 10 may be configured for use in any suitable application, such as any suitable automotive or non-automotive application. The battery cell 10 includes C cathode electrodes 20, A anode electrodes 40, and S separators 32 arranged in a predetermined sequence in a stack 12, which is seated in an enclosure 50. C, A, and S are integers, which are each greater than one. In some examples, A=C+1. The C cathode electrodes 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

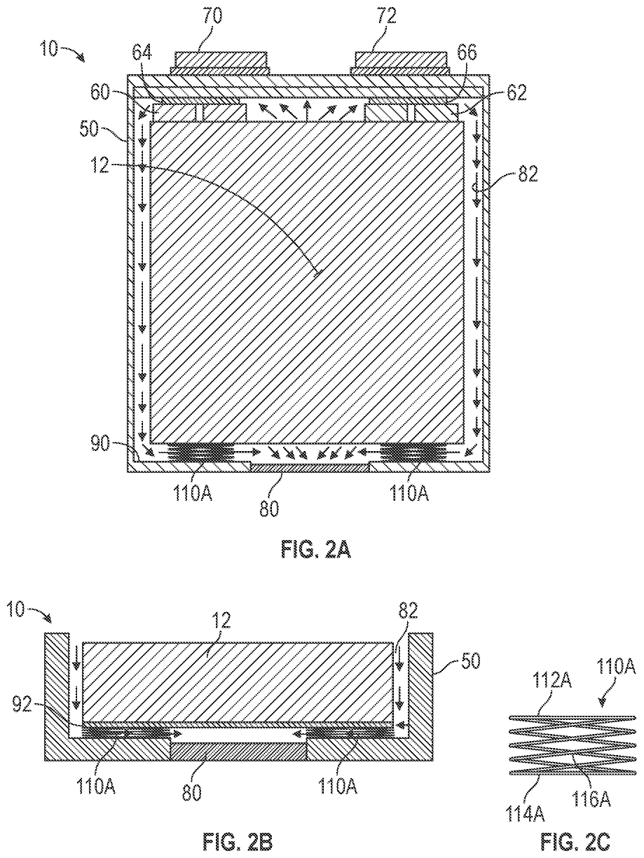

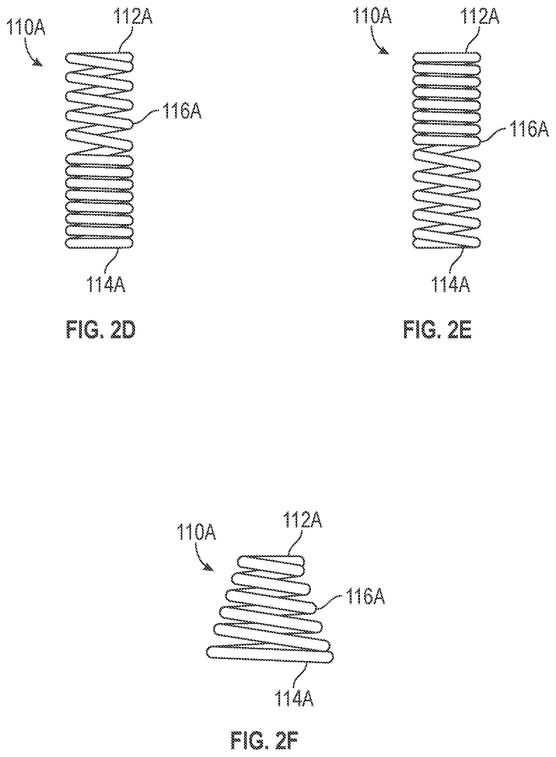

FIG. 2A illustrates additional features of the battery cell 10. In the example of FIG. 2A, the battery cell 10 is configured as a tall prismatic cell. The enclosure 50 may have a rectangular cross-section, or a cross-section of any other suitable shape. The cathode current collectors 26 and/or the anode current collectors 46 include external connector tabs 60 and 62 respectively, which are laser welded to internal terminals 64 and 66 contacting external terminals 70 and 72 of the battery cell 10.

The enclosure 50 includes a vent 80. The vent 80 is configured to open to relieve pressure within the enclosure 50, such as during a thermal runaway event. For example, in the case of a thermal runaway event gasses may be released from the stack 12. FIG. 2A includes arrows 82, which represent exemplary gas flow during a thermal runaway event. The vent 80 is configured in any suitable manner to open to release the gas from within the enclosure 50 when pressure of the gas within the enclosure 50 exceeds a predetermined threshold. In the example illustrated, the vent 80 is at a bottom surface 90 of the enclosure 50 opposite to the tabs 60 and 62, which are at a top of the enclosure 50. The vent 80 may be arranged at any other suitable location about the enclosure 50 as well.

The stack 12 is supported within the enclosure 50 by one or more battery electrode stack brackets. In the examples illustrated, the brackets are seated on the bottom surface 90. The brackets may be arranged at any other suitable locations about the enclosure 50 as well. As explained herein, the brackets define passageways configured to allow gas released from the stack 12 to flow through the brackets, such as to the vent 80 at the bottom surface 90 or at any suitable location throughout the enclosure 50.

The brackets may be in contact with the stack 12 directly or indirectly. For example, an insolation film 92 may be arranged between the stack 12 and the brackets, as illustrated in FIG. 2B. The isolation film 92 may be any suitable isolation material, such as any suitable film or layer. The isolation film 92 is configured to lessen stress concentration on the brackets, and/or to provide additional isolation between the brackets and the stack 12 if the brackets are made of metal.

FIGS. 2A, 2B, and 2C illustrate an exemplary bracket 110A in accordance with the present disclosure. The bracket 110A is configured to support the stack 12 within the enclosure, and to allow gases released from the stack 12 during a thermal runaway event to flow through the bracket 110A to the vent 80. FIGS. 2A and 2B illustrate two of the brackets 110A spaced apart on opposite sides of the bottom vent 80. The battery cell 10 may include any other suitable number of brackets 110A, such as one, three, or more.

Each one of the brackets 110A is generally shaped like a coil or spring. The brackets 110A define many passageways between the coils to allow gas to pass through the brackets 110A. The brackets 110A are generally not flexible, but may be configured to flex based on the application. In the example of FIG. 2C, the bracket 110A includes a top end 112A and a bottom end 114A, each of which has the same diameter, or generally the same diameter. Coils 116A define the passageways for the gas to flow through the bracket 110A. Furthermore, the bracket 110A of FIG. 2C includes uniform spacing (uniform pitch) between the coils 116A along the length of the bracket 110A. The bracket 110A may be sized and shaped in any other suitable manner.

For example and as illustrated in FIG. 2D, the bracket 110A may include a coil pitch at a top half that is relatively larger than a coil pitch at a bottom half. In the example of FIG. 2E, a coil pitch at the top half may be relatively smaller than a coil pitch at the bottom half. In the example of FIG. 2F, the diameter at the bottom end 114A may be larger than the diameter at the top end 112A. In another example, each coil 116A of the bracket 110A may include a different pitch such that neighboring coils 116A have different pitches. The bracket 110A may also be configured such that groups of coils 116A have different pitches, with each coil 116A of a particular group having the same pitch. The bracket 110A may include any other suitable pitch and diameter dimensions as well.

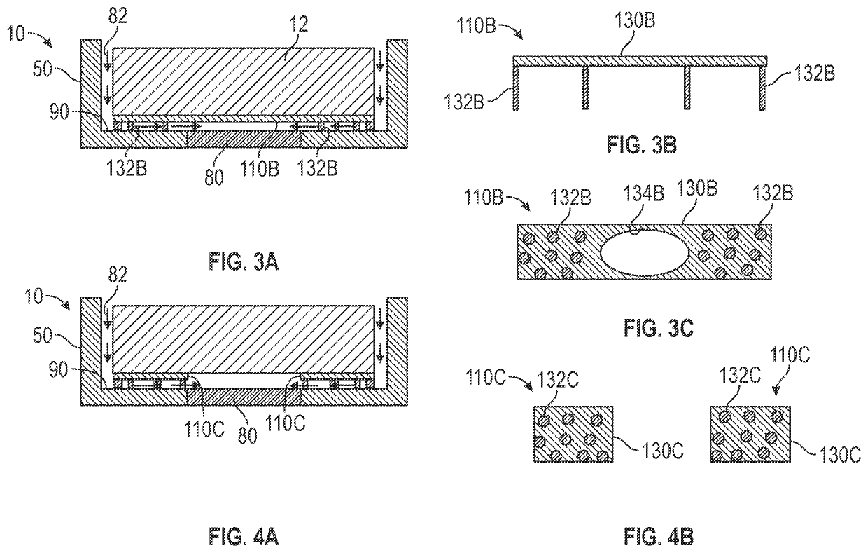

FIGS. 3A, 3B, and 3C illustrate another bracket 110B in accordance with the present disclosure for supporting the stack 12 within the enclosure 50. The bracket 110B includes a base 130B, which is generally planar. Extending from the base 130B are a plurality of legs 132B. The legs 132B stand on the bottom surface 90 of the enclosure 50. With particular reference to FIG. 3C, the legs 132B are spaced apart and staggered to define passageways configured to allow gas released from the stack 12, such as during a thermal runaway event, to pass between the legs 132B to the vent 80. The base 130B defines a passageway in the form of an opening 134B at a center thereof to allow gas released from a bottom of the stack 12 to pass through the base 130B to the bottom vent 80. The opening 134B may have any suitable shape, such as oval, circular, rectangular, square, etc.

FIGS. 4A and 4B illustrate a pair of brackets 110C in accordance with the present disclosure for supporting the stack 12. The brackets 110C each include a base 130C, which is generally planar. Extending from each base 130C are legs 132C. The legs 132C are spaced apart and staggered to define passageways configured to allow gas released from the stack 12, such as during a thermal runaway event, to pass between the legs 132C to the vent 80. The two brackets 110C are arranged on the bottom surface 90 spaced apart on opposite sides of the stack 12 to allow gas released from the stack 12 to flow to the vent 80 unobstructed.

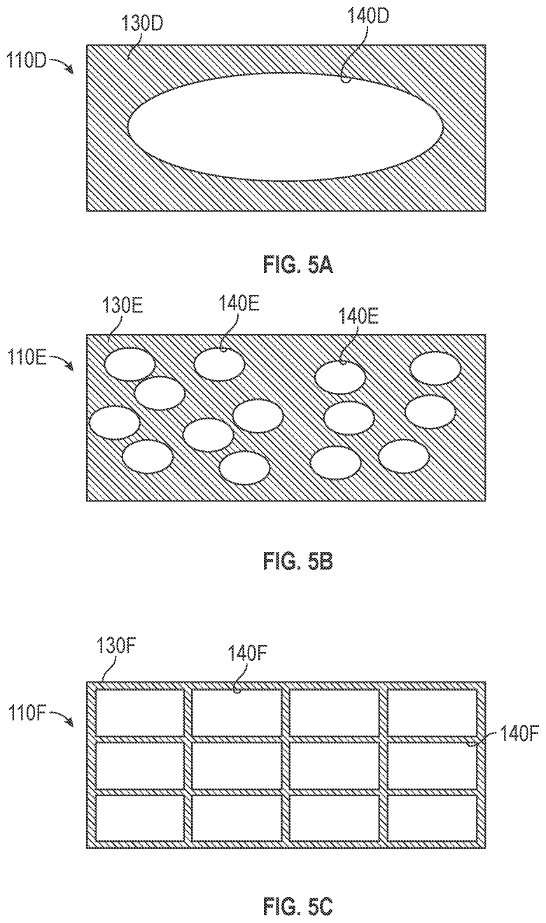

FIGS. 5A, 5B, and 5C illustrate additional brackets 110D, 110E, and 110F in accordance with the present disclosure for supporting the stack 12 within the enclosure 50, and configured to allow gas released from the stack 12 to flow through the brackets 110D, 110E, and 110F to the vent 80. The bracket 110D includes a base 130D defining a passageway in the form of an opening 140D at a center of, or generally a center of, the base 130D. The opening 140D may be oval as illustrated, or have any other suitable shape. The bracket 110E includes a base 130E defining a plurality of passageways in the form of openings 140E staggered about the base 130E. The openings 140E may be oval as illustrated, or have any other suitable shape. The bracket 110F includes a base 130F defining a plurality of passageways in the form of openings 140F, which may be rectangular as illustrated, or have any other suitable shape.

To support the stack 12 spaced apart from the bottom surface 90 of the enclosure 50, the bases 130D, 130E, 130F are folded one or more times at any suitable angle, such as at an angle less than 90°, greater than 90°, or at a 90° angle. The folded bases 130D, 130E, 130F are then seated on the bottom surface 90 to support the stack 12. The openings 140D, 140E, 140F allow gas released from the stack 12 to flow through the brackets 110D, 110E, 110F to the vent 80.

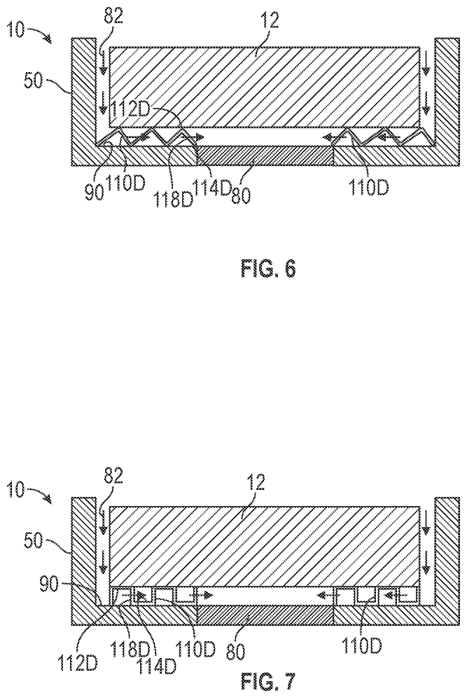

FIG. 6 illustrates two of the brackets 110D spaced apart on opposite sides of the vent 80 and folded to have a wave-like or sawtooth-like shape as viewed from a long side of a rectangular prismatic battery cell 10. For example, an upper end 112D is in contact with the stack 12, a lower end 114D is in contact with the bottom surface 90, and an intermediate surface 118D extends therebetween at an acute angle relative to the bottom surface 90. FIG. 7 illustrates two of the brackets 110D folded to have a pillar-like shape as viewed from a long side of a rectangular prismatic battery cell 10. In the example of FIG. 7, the intermediate surface 118D extends at a right angle to the upper end 112D and the lower end 114D, and at a right angle to the bottom surface 90. The brackets 110E and 110F may be folded in a similar manner and likewise positioned in FIGS. 6 and 7. Thus, in FIG. 6 the bracket 110D may be replaced with the bracket 110E or 110F. And in FIG. 7 the bracket 110D may be replaced with the bracket 110E or 110F. Regardless of whether the brackets 110D, 110E, 110F are folded as illustrated in FIG. 6 or FIG. 7, or folded in any other suitable manner, the openings 140D, 140E, 140F provide passageways configured to allow gas released from the stack 12 to flow through the brackets 110D, 110E, 110F to the vent 80, such as during a thermal runaway event.

Each of the brackets 110A, 110B, 110C, 110D, 110E, 110F may be made of any suitable material, such as any suitable polymeric material, metallic material, polymer coated metals, carbon fiber composite, etc. Exemplary polymeric materials include, but are not limited to, the following: polytetrafluoroethylene (PTFE), polyethylene (PE), polypropylene (PP), etc. Exemplary metallic materials include, but are not limited to, the following: stainless steel, copper, aluminum, etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in a different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
an enclosure;
a stack of anode electrodes and cathode electrodes within the enclosure;
a vent configured to open to release gas out from within the enclosure when pressure within the enclosure exceeds a threshold; and
a bracket within the enclosure supporting the stack, the bracket defining at least one passageway through the bracket configured to allow gas to flow through the bracket to the vent.

2. The battery cell of claim 1, wherein the battery cell is configured as a prismatic cell.

3. The battery cell of claim 1, wherein the enclosure includes a bottom surface, and the vent is at the bottom surface.

4. The battery cell of claim 1, wherein the enclosure includes a bottom surface, and the bracket is seated on the bottom surface.

5. The battery cell of claim 1, wherein the bracket includes coils defining the at least one passageway.

6. The battery cell of claim 5, wherein the coils have a uniform pitch.

7. The battery cell of claim 5, wherein the coils include upper coils having an upper pitch and lower coils having a lower pitch, the upper pitch is less than the lower pitch.

8. The battery cell of claim 5, wherein the coils include upper coils having an upper pitch and lower coils having a lower pitch, the upper pitch is greater than the lower pitch.

9. The battery cell of claim 5, wherein an upper diameter of the bracket is less than a lower diameter of the bracket.

10. The battery cell of claim 1, wherein the bracket includes a base and a plurality of legs extending from the base, the legs defining the at least one passageway for gas to flow through the bracket.

11. The battery cell of claim 10, wherein the at least one passageway further includes an opening defined by the base.

12. The battery cell of claim 1, wherein:
the bracket is a first bracket, the battery cell further including a second bracket; and
the first bracket and the second bracket are on opposite sides of the vent.

13. The battery cell of claim 1, wherein the bracket includes an upper end in contact with the stack, a lower end in contact with a bottom surface of the enclosure, and an intermediate surface extending between the upper end and the lower end.

14. The battery cell of claim 13, wherein the intermediate surface extends perpendicular to the bottom surface of the enclosure.

15. The battery cell of claim 13, wherein the intermediate surface extends at an acute angle relative to the bottom surface of the enclosure.

16. A battery cell comprising:
a prismatic enclosure;
a stack of anode electrodes and cathode electrodes within the prismatic enclosure;
a vent at a bottom surface of the prismatic enclosure, the vent configured to open to release gas out from within the prismatic enclosure when pressure within the prismatic enclosure exceeds a threshold; and
at least one bracket within the prismatic enclosure supporting the stack, the at least one bracket seated on the bottom surface of the prismatic enclosure and defining passageways on opposite sides of the vent for gas to flow through the at least one bracket to the vent.

17. The battery cell of claim 16, further comprising an isolation material between the stack and the at least one bracket.

18. A battery cell comprising:
a prismatic battery cell enclosure;
an anode terminal and a cathode terminal at an upper, exterior surface of the prismatic battery cell enclosure;
a stack of anode electrodes and cathode electrodes within the prismatic battery cell enclosure, the anode electrodes connected to the anode terminal and the cathode electrodes connected to the cathode terminal;
a vent at a bottom surface of the prismatic battery cell enclosure, the bottom surface is opposite to the exterior surface of the prismatic battery cell enclosure, the vent configured to open to release gas out from within the prismatic battery cell enclosure when pressure within the prismatic battery cell enclosure exceeds a threshold; and
at least one bracket within the prismatic battery cell enclosure supporting the stack, the at least one bracket seated on the bottom surface of the prismatic battery cell enclosure and defining passageways on opposite sides of the vent for gas to flow through the at least one bracket to the vent.

19. The battery cell of claim 18, wherein the at least one bracket includes a pair of coils on opposite sides of the vent.

20. The battery cell of claim 18, wherein the at least one bracket includes a base and a plurality of legs extending from the base, the legs defining the passageways.
